(19) United States
(12) Patent Application Publication
(10) Pub. No.: US 2023/0199517 A1
(43) Pub. Date: Jun. 22, 2023

(54) METHOD, APPARATUS AND COMPUTER PROGRAM

(71) Applicant: NOKIA TECHNOLOGIES OY, Espoo (FI)

(72) Inventor: Keeth Saliya Jayasinghe LADDU, Espoo (FI)

(21) Appl. No.: 17/999,205

(22) PCT Filed: May 18, 2020
(86) PCT No.: PCT/EP2020/063806

§ 371 Date: Nov. 17, 2022

(51) Int. Cl. H04W 16/28; H04W 24/10

(52) U.S. Cl. CPC H04W 16/28; H04W 24/10

(57) ABSTRACT

There is provided an apparatus, said apparatus comprising means for receiving, at a user equipment from a network, a configuration that enables group-based beam reporting, receiving an indication that the group-based beam reporting is associated with a first transmit receive point, TRP, or a group of TRPs, the group of TRPs comprising at least the first TRP and a second TRP, first determining whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP and, if so determining, based at least in part on the first determining, to report the at least two beams to the network.

### FIELD

The present application relates to a method, apparatus, system and computer program and, in particular but not exclusively, to enhanced group-based beam reporting for multi-TRP operation.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices (also referred to as station or user equipment) and/or application servers. The communication sessions may comprise, for example, communication of data for carrying communications such as voice, video, electronic mail (email), text message, multimedia, content data, time-sensitive network (TSN) flows and/or data in an industrial application such as critical system messages between an actuator and a controller, critical sensor data (such as measurements, video feed etc.) towards a control system and so on. Non-limiting examples of services provided comprise two-way or multi-way calls, data communication or multimedia services and access to a data network system, such as the Internet.

In a wireless communication system at least a part of a communication session, for example, between at least two stations or between at least one station and at least one application server (e.g. for video), occurs over a wireless link. Examples of wireless systems comprise public land mobile networks (PLMN) operating based on 3GPP radio standards such as E-UTRA, New Radio, satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access one or more carriers provided by the network, for example a base station of a cell, and transmit and/or receive communications on the one or more carriers. In carrier aggregation (CA) two or more carriers are combined into one channel. In dual connectivity (DC), two carriers from different sites are combined, that is a user equipment may be dual (or multi) connected to two (or more) sites.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) based on the E-UTRAN radio-access technology, and so-called 5G system (5GS) including the 5G or next generation core (NGC) and the 5G Access network based on the New Radio (NR) radio-access technology. 5GS including NR are being standardized by the 3rd Generation Partnership Project (3GPP).

### SUMMARY

In a first aspect there is provided an apparatus, said apparatus comprising means for receiving, at a user equipment from a network, a configuration that enables group-based beam reporting, receiving an indication that the group-based beam reporting is associated with a first transmit receive point, TRP, or a group of TRPs, the group of TRPs comprising at least the first TRP and a second TRP, first determining whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP and, if so determining, based at least in part on the first determining, to report the at least two beams to the network.

If the group-based beam reporting is associated with the group of TRPs, the at least two beams may comprise resources which are received at the user equipment using multiple spatial receive filters.

If the group-based beam reporting is associated with the group of TRPs, the means for first determining may comprise means for determining whether the beam of the at least two beams associated with the first TRP is received at a first panel and the at least one other beam of the at least two beams associated with the second TRP is received at a second panel.

If the group-based beam reporting is associated with the first TRP, the at least two beams may comprise resources which are received at the user equipment using a single spatial receive filter.

If the group-based beam reporting is associated with the first TRP, the means for first determining may comprise means for determining whether the at least two beams associated with the first TRP are received at a given panel of at least two panels of the user equipment.

The apparatus may comprise means for providing at least two identifiers from the user equipment to the network, each identifier associated with one of the at least two beams.

Means for determining to report the at least two beams may comprise means for providing an indication of a beam measurement for each of the at least two beams.

The apparatus may comprise means for determining that at least two beams are not received simultaneously at the user equipment, determining to report a strongest beam received at the user equipment and providing an indication of a beam measurement for the strongest beam and a null indication to the network.

The apparatus may comprise means for associating a beam received at the user equipment with at least one of the first TRP and the second TRP based on the configuration that enables group-based beam reporting.

The apparatus may comprise means for associating the beam received at the user equipment with at least one of the first TRP and the second TRP based on a higher layer index or a quasi co-location reference.

The indication that the group-based beam reporting is associated with the group of TRPs or that the group-based beam reporting is associated with the first TRP may comprise a higher layer index.

The higher layer index may be associated with a CORESET.

The apparatus may comprise means for receiving the indication at the user equipment from the network in dynamic signalling.

In a second aspect there is provided an apparatus comprising means for providing, to a user equipment from a network, a configuration that enables group-based beam reporting, providing an indication to the user equipment from the network that the group-based beam reporting is associated with a first transmit receive point, TRP, or a group of TRPs, the group of TRPs comprising at least the first TRP and a second TRP and receiving reports from the user equipment at the network for at least two beams received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

The apparatus may comprise means for receiving at least two identifiers at the network from the user equipment, each identifier associated with one of the at least two beams.

The means for receiving reports for the at least two beams may comprise means for receiving a beam measurement for each of the at least two beams.

The apparatus may comprise means for, in response to receiving the beam measurements from the user equipment at the network, at least one of providing an indication from the user equipment to the user equipment to enable further group-based beam reporting, wherein the further group-based beam reporting is associated with the group of TRPs or the first TRP and modifying transmission configuration indicator states associated with a given TRP.

The apparatus may comprise means for receiving from the user equipment at the network an indication of beam measurement for a strongest beam received at the user equipment and a null indication.

The indication that the group-based beam reporting is associated with the group of TRPs or that the group-based beam reporting is associated with the first TRP may comprise a higher layer index.

The higher layer index may be associated with a CORESET.

The apparatus may comprise means for providing the indication to the user equipment in dynamic signalling.

In a third aspect, there is provided a method comprising receiving, at a user equipment from a network, a configuration that enables group-based beam reporting, receiving an indication that the group-based beam reporting is associated with a first transmit receive point, TRP, or a group of TRPs, the group of TRPs comprising at least the first TRP and a second TRP, first determining whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP and, if so determining, based at least in part on the first determining, to report the at least two beams to the network.

If the group-based beam reporting is associated with the group of TRPs, the at least two beams may comprise resources which are received at the user equipment using multiple spatial receive filters.

If the group-based beam reporting is associated with the group of TRPs, first determining may comprise determining whether the beam of the at least two beams associated with the first TRP is received at a first panel and the at least one other beam of the at least two beams associated with the second TRP is received at a second panel.

If the group-based beam reporting is associated with the first TRP, the at least two beams may comprise resources which are received at the user equipment using a single spatial receive filter.

If the group-based beam reporting is associated with the first TRP, first determining may comprise determining whether the at least two beams associated with the first TRP are received at a given panel of at least two panels of the user equipment.

The method may comprise providing at least two identifiers from the user equipment to the network, each identifier associated with one of the at least two beams.

Determining to report the at least two beams may comprise providing an indication of a beam measurement for each of the at least two beams.

The method may comprise determining that at least two beams are not received simultaneously at the user equipment, determining to report a strongest beam received at the user equipment and providing an indication of a beam measurement for the strongest beam and a null indication to the network.

The method may comprise associating a beam received at the user equipment with at least one of the first TRP and the second TRP based on the configuration that enables group-based beam reporting.

The method may comprise associating the beam received at the user equipment with at least one of the first TRP and the second TRP based on a higher layer index or a quasi co-location reference.

The indication that the group-based beam reporting is associated with the group of TRPs or that the group-based beam reporting is associated with the first TRP may comprise a higher layer index.

The higher layer index may be associated with a CORESET.

The method may comprise receiving the indication at the user equipment from the network in dynamic signalling.

In a fourth aspect there is provided a method comprising providing, to a user equipment from a network, a configuration that enables group-based beam reporting, providing an indication to the user equipment from the network that the group-based beam reporting is associated with a first transmit receive point, TRP, or a group of TRPs, the group of TRPs comprising at least the first TRP and a second TRP and receiving reports from the user equipment at the network for at least two beams received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

The method may comprise receiving at least two identifiers at the network from the user equipment, each identifier associated with one of the at least two beams.

Receiving reports for the at least two beams may comprise receiving a beam measurement for each of the at least two beams.

The method may comprise, in response to receiving the beam measurements from the user equipment at the network, at least one of providing an indication from the user equipment to the user equipment to enable further group-based beam reporting, wherein the further group-based beam reporting is associated with the group of TRPs or the first TRP and modifying transmission configuration indicator states associated with a given TRP.

The method may comprise receiving from the user equipment at the network an indication of beam measurement for a strongest beam received at the user equipment and a null indication.

The indication that the group-based beam reporting is associated with the group of TRPs or that the group-based beam reporting is associated with the first TRP may comprise a higher layer index.

The higher layer index may be associated with a CORESET.

The method may comprise providing the indication to the user equipment in dynamic signalling.

In a fifth aspect there is provided an apparatus comprising: at least one processor and at least one memory including a computer program code, the at least one memory and computer program code configured to, with the at least one processor, cause the apparatus at least to: receive, at a user equipment from a network, a configuration that enables group-based beam reporting, receive an indication that the group-based beam reporting is associated with a first transmit receive point, TRP, or a group of TRPs, the group of TRPs comprising at least the first TRP and a second TRP, first determine whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP and, if so determine, based at least in part on the first determining, to report the at least two beams to the network.

If the group-based beam reporting is associated with the group of TRPs, the at least two beams may comprise resources which are received at the user equipment using multiple spatial receive filters.

If the group-based beam reporting is associated with the group of TRPs, the apparatus may be configured to determine whether the beam of the at least two beams associated with the first TRP is received at a first panel and the at least one other beam of the at least two beams associated with the second TRP is received at a second panel.

If the group-based beam reporting is associated with the first TRP, the at least two beams may comprise resources which are received at the user equipment using a single spatial receive filter.

If the group-based beam reporting is associated with the first TRP, the apparatus may be configured to determine whether the at least two beams associated with the first TRP are received at a given panel of at least two panels of the user equipment.

The apparatus may be configured to provide at least two identifiers from the user equipment to the network, each identifier associated with one of the at least two beams.

The apparatus may be configured to provide an indication of a beam measurement for each of the at least two beams.

The apparatus may be configured to determine that at least two beams are not received simultaneously at the user equipment, determine to report a strongest beam received at the user equipment and provide an indication of a beam measurement for the strongest beam and a null indication to the network.

The apparatus may be configured to associate a beam received at the user equipment with at least one of the first TRP and the second TRP based on the configuration that enables group-based beam reporting.

The apparatus may be configured to associate the beam received at the user equipment with at least one of the first TRP and the second TRP based on a higher layer index or a quasi co-location reference.

The indication that the group-based beam reporting is associated with the group of TRPs or that the group-based beam reporting is associated with the first TRP may comprise a higher layer index.

The higher layer index may be associated with a CORESET.

The apparatus may be configured to receive the indication at the user equipment from the network in dynamic signalling.

In a sixth aspect there is provided an apparatus comprising: at least one processor and at least one memory including a computer program code, the at least one memory and computer program code configured to, with the at least one processor, cause the apparatus at least to: provide, to a user equipment from a network, a configuration that enables group-based beam reporting, provide an indication to the user equipment from the network that the group-based beam reporting is associated with a first transmit receive point, TRP, or a group of TRPs, the group of TRPs comprising at least the first TRP and a second TRP and receive reports from the user equipment at the network for at least two beams received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

The apparatus may be configured to receive at least two identifiers at the network from the user equipment, each identifier associated with one of the at least two beams.

The apparatus may be configured to receive a beam measurement for each of the at least two beams.

The apparatus may be configured to, in response to receiving the beam measurements from the user equipment at the network, at least one of provide an indication from the user equipment to the user equipment to enable further group-based beam reporting, wherein the further group-based beam reporting is associated with the group of TRPs or the first TRP and Modify transmission configuration indicator states associated with a given TRP.

The apparatus may be configured to receive from the user equipment at the network an indication of beam measurement for a strongest beam received at the user equipment and a null indication.

The indication that the group-based beam reporting is associated with the group of TRPs or that the group-based beam reporting is associated with the first TRP may comprise a higher layer index.

The higher layer index may be associated with a CORESET.

The apparatus may be configured to provide the indication to the user equipment in dynamic signalling.

In a seventh aspect there is provided a computer readable medium comprising program instructions for causing an apparatus to perform at least the following receiving, at a user equipment from a network, a configuration that enables group-based beam reporting, receiving an indication that the group-based beam reporting is associated with a first transmit receive point, TRP, or a group of TRPs, the group of TRPs comprising at least the first TRP and a second TRP, first determining whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP and, if so, determining, based at least in part on the first determining, to report the at least two beams to the network.

If the group-based beam reporting is associated with the group of TRPs, the at least two beams may comprise resources which are received at the user equipment using multiple spatial receive filters.

If the group-based beam reporting is associated with the group of TRPs, the apparatus may be caused to perform determining may comprise means for determining whether the beam of the at least two beams associated with the first TRP is received at a first panel and the at least one other beam of the at least two beams associated with the second TRP is received at a second panel.

If the group-based beam reporting is associated with the first TRP, the at least two beams may comprise resources which are received at the user equipment using a single spatial receive filter.

If the group-based beam reporting is associated with the first TRP, first determining may comprise determining whether the at least two beams associated with the first TRP are received at a given panel of at least two panels of the user equipment.

The apparatus may be caused to perform providing at least two identifiers from the user equipment to the network, each identifier associated with one of the at least two beams.

Determining to report the at least two beams may comprise providing an indication of a beam measurement for each of the at least two beams.

The apparatus may be caused to perform determining that at least two beams are not received simultaneously at the user equipment, determining to report a strongest beam received at the user equipment and providing an indication of a beam measurement for the strongest beam and a null indication to the network.

The apparatus may be caused to perform associating a beam received at the user equipment with at least one of the first TRP and the second TRP based on the configuration that enables group-based beam reporting.

The apparatus may be caused to perform associating the beam received at the user equipment with at least one of the first TRP and the second TRP based on a higher layer index or a quasi co-location reference.

The indication that the group-based beam reporting is associated with the group of TRPs or that the group-based beam reporting is associated with the first TRP may comprise a higher layer index.

The higher layer index may be associated with a CORESET.

The apparatus may be caused to perform receiving the indication at the user equipment from the network in dynamic signalling.

In an eighth aspect there is provided computer readable medium comprising program instructions for causing an apparatus to perform at least the following providing, to a user equipment from a network, a configuration that enables group-based beam reporting, providing an indication to the user equipment from the network that the group-based beam reporting is associated with a first transmit receive point, TRP, or a group of TRPs, the group of TRPs comprising at least the first TRP and a second TRP and receiving reports from the user equipment at the network for at least two beams received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

The apparatus may be caused to perform receiving at least two identifiers at the network from the user equipment, each identifier associated with one of the at least two beams.

Receiving reports for the at least two beams may comprise receiving a beam measurement for each of the at least two beams.

The apparatus may be caused to perform, in response to receiving the beam measurements from the user equipment at the network, at least one of providing an indication from the user equipment to the user equipment to enable further group-based beam reporting, wherein the further group-based beam reporting is associated with the group of TRPs or the first TRP and modifying transmission configuration indicator states associated with a given TRP.

The apparatus may be caused to perform receiving from the user equipment at the network an indication of beam measurement for a strongest beam received at the user equipment and a null indication.

The indication that the group-based beam reporting is associated with the group of TRPs or that the group-based beam reporting is associated with the first TRP may comprise a higher layer index.

The higher layer index may be associated with a CORESET.

The apparatus may be caused to perform providing the indication to the user equipment in dynamic signalling.

In a ninth aspect there is provided a non-transitory computer readable medium comprising program instructions for causing an apparatus to perform at least the method according to the third aspect or a method according to the fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 shows a schematic diagram of a multi-TRP operation in FR2;

FIG. 5 shows a flowchart of a method according to an example embodiment;

FIG. 6 shows a flowchart of a method according to an example embodiment;

FIG. 7 shows a schematic diagram of across TRP group-based beam reporting;

FIG. 8 shows a schematic diagram of per TRP group-based beam reporting;

FIG. 9 shows a signalling flow according to an example embodiment;

FIG. 10 shows a signalling flow according to an example embodiment;

FIG. 11 shows a signalling flow according to an example embodiment.

### DETAILED DESCRIPTION

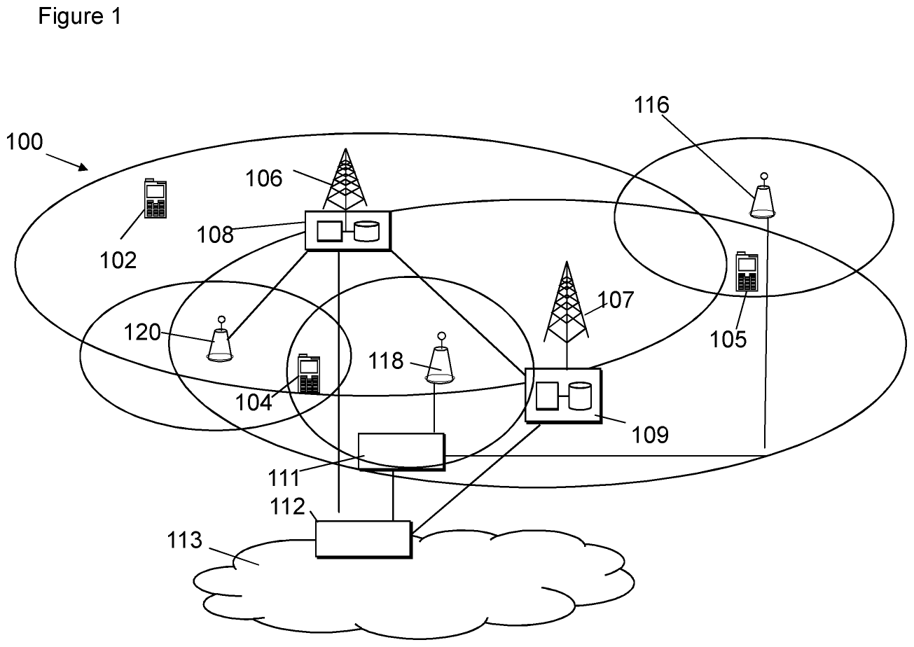

Before explaining in detail the examples, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices or user equipment (UE) 102, 104, 105 are provided wireless access via at least one base station (e.g. next generation NB, gNB) or similar wireless transmitting and/or receiving node or point. Base stations may be controlled or assisted by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatuses. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UE(s) exchanging traffic with the DN.

The UPF is controlled by an SMF (Session Management Function) that receives policies from a PCF (Policy Control Function). The CN may also include an AMF (Access & Mobility Function).

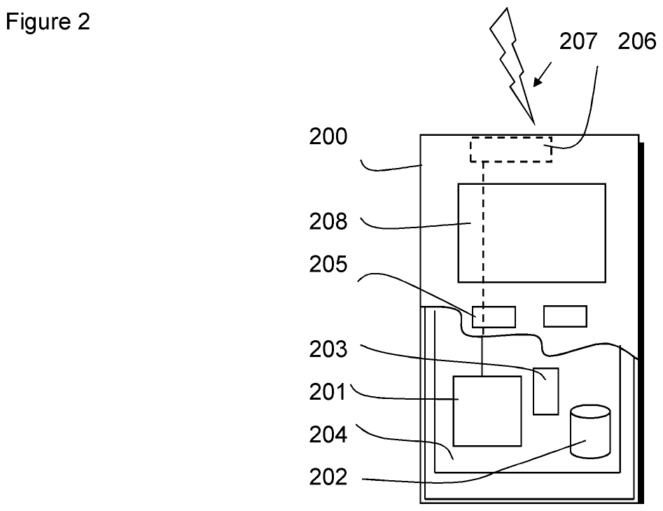

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

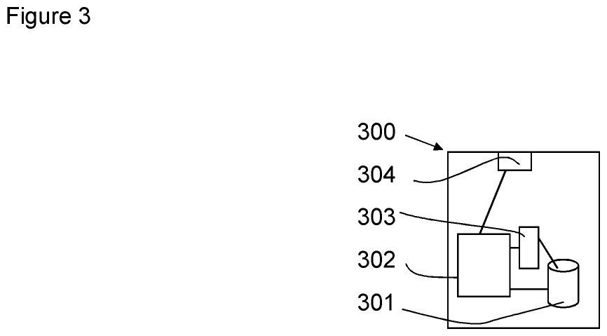

FIG. 3 shows an example embodiment of a control apparatus for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

In NR MIMO enhancements for Rel-16, multi-TRP was considered as an essential component due to the benefits for eMBB operations as well as the capability for improving reliability for the URLLC services.

The work item description of MIMO enhancements states that enhancements on multi-TRP/panel transmission including improved reliability and robustness with both ideal and non-ideal backhaul may include specifying downlink control signalling enhancement(s) for efficient support of non-coherent joint transmission, performing study and, if needed, specifying enhancements on uplink control signalling and/or reference signal(s) for non-coherent joint transmission and multi-TRP techniques for URLLC requirements.

In Rel-16, RAN1 discussed URLLC schemes for PDSCH and the basic framework of non-coherent joint transmission schemes based on single and multiple PDCCH design. In Rel-17, some objectives are stated as below.

Enhancement on the support for multi-TRP deployment, targeting both FR1 and FR2:
a. Identify and specify features to improve reliability and robustness for channels other than PDSCH (that is, PDCCH, PUSCH, and PUCCH) using multi-TRP and/or multi-panel, with Rel. 16 reliability features as the baseline
b. Identify and specify QCL/TCI-related enhancements to enable inter-cell multi-TRP operations, assuming multi-DCI based multi-PDSCH reception
c. Evaluate and, if needed, specify beam-management-related enhancements for simultaneous multi-TRP transmission with multi-panel reception
d. Enhancement to support HST-SFN deployment scenario:
   i. Identify and specify solution(s) on QCL assumption for DMRS, e.g. multiple QCL assumptions for the same DMRS port(s), targeting DL-only transmission
   ii. Evaluate and, if the benefit over Rel. 16 HST enhancement baseline is demonstrated, specify QCL/QCL-like relation (including applicable type(s) and the associated requirement) between DL and UL signal by unified TCI framework
      - - - <text omitted> - - -

4. Enhancement on CSI measurement and reporting:
a. Evaluate and, if needed, specify CSI reporting for DL multi-TRP and/or multi-panel transmission to enable more dynamic channel/interference hypotheses for NCJT, targeting both FR1 and FR2

The following is focused on further enhancements related to beam reporting considering multiple PDCCH based multi-TRP transmission.

There have been discussions on how to support the multi-DCI based multi-TRP operation. The main agreement that defined configuring multi-DCI based multi-TRP was to support multiple-PDCCH based multi-TRP/panel transmission with intra-cell (same cell ID) and inter-cell (different Cell IDs), following RRC configuration can be used to link multiple PDCCH/PDSCH pairs with multiple TRPs. One CORESET in a “PDCCH-config” corresponds to one TRP.

Based on further discussions, RAN1 agreed to consider the higher layer index per CORESET to differentiate the multi-DCI based multi-TRP transmission from other transmissions.

If a UE is configured by higher layer parameter PDCCH-Config that contains two different values of CORESETPoolIndex in ControlResourceSet for the active BWP of a serving cell, the UE may expect to receive multiple PDCCHs scheduling fully/partially/non-overlapped PDSCHs in time and frequency domain subject to UE capability. This allows a UE to be not configured with either joint HARQ ACK feedback or separate HARQ ACK feedback. For the CORESET without CORESETPoolIndex, the UE may assume that the CORESET is assigned with CORESETPoolIndex as 0

Multi-DCI based multi-TRP transmission was designed to support both ideal and non-ideal BH scenarios. Therefore, certain Rel-15 behaviours, such as in order operations, may be relaxed.

For multi-DCI based multi-TRP, when PDCCHs schedule two PDSCHs/PUSCHs across TRPs, i.e. PDCCHs are associated with different values of CORESETPoolIndex, the following operations are allowed:

For PDCCH to PDSCH, for any two HARQ process IDs in a given scheduled cell, if the UE is scheduled to start receiving a first PDSCH starting in symbol j by a PDCCH associated with a value of CORESETPoolIndex ending in symbol i, the UE can be scheduled to receive a PDSCH starting earlier than the end of the first PDSCH with a PDCCH associated with a different value of CORESETPoolIndex that ends later than symbol i.

For PDCCH to PUSCH, for any two HARQ process IDs in a given scheduled cell, if the UE is scheduled to start a first PUSCH transmission starting in symbol j by a PDCCH associated with a value of CORESETPoolIndex ending in symbol i, the UE can be scheduled to transmit a PUSCH starting earlier than the end of the first PUSCH by a PDCCH associated with a different value of CORESETPoolIndex that ends later than symbol i. Note that from the UE perspective, it does not imply overlapped PUSCHs at the time.

For PDSCH to HARQ-ACK, in a given scheduled cell, the UE can receive a first PDSCH in slot i, with the corresponding HARQ-ACK assigned to be transmitted in slot j, and a second PDSCH associated with a CORESETPoolindex different from the first PDSCH starting later than the first PDSCH with its corresponding HARQ-ACK assigned to be transmitted in a slot before slot j.

These features are optional for a UE that supports multi-DCI based multi-TRP.

The discussions in Rel-16 may provide support for basic features of multi-DCI based multi-TRP transmissions, enhancements may be needed in different areas (which were identified by Rel-17 work scope) to support FR2 operation.

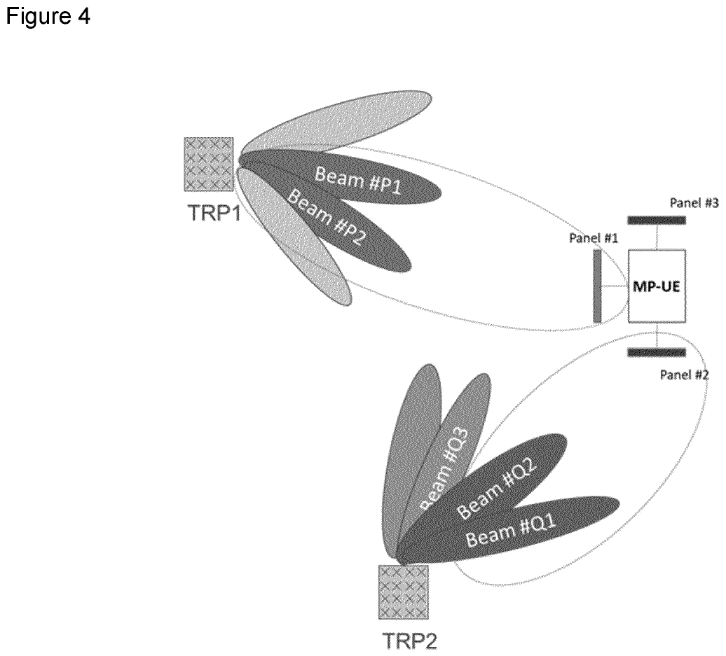

Rel-16 multi-DCI based multi-TRP operation in FR2 may be limited due to the lack of support for beam management to support efficient operation. FIG. 4 shows a schematic diagram of an example multi-TRP operation in FR2. When the UE is using multiple panels, not all beams may be suitable to use in non-coherent joint transmission (NCJT) towards the UE even though those beams can be separately received by the UE (via single TRP transmission).

That is there are not many occasions in FR2 where a UE would be able to receive simultaneously from two TRPs unless the UE has different panels. The benefit for the network of scheduling transmission on both beams may not be achieved unless the network knows in advance that the UE can receive them.

Rel-15 group-based beam reporting may be used in the multi-TRP operation. However, the use of Rel-15 beam reporting functionality or any other implementation-specific solutions of multi-panel (MP) UE may not be efficient to support multi-TRP operation for FR2.

In Rel-15, group-based beam reporting is supported, and TS 38.214 captures the following,

If the UE is configured with a CSI-ReportConfig with the higher layer parameter reportQuantity set to ‘cri-RSRP’ or ‘ssb-Index-RSRP’,
if the UE is configured with the higher layer parameter groupBasedBeamReporting set to ‘disabled’, the UE is not required to update measurements for more than 64 CSI-RS and/or SSB resources, and the UE shall report in a single report nrofReportedRS (higher layer configured) different CRI or SSBRI for each report setting.
if the UE is configured with the higher layer parameter groupBasedBeamReporting set to ‘enabled’, the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.

TS 38.331 captures the following,

### CSI-ReportConfig Information Element

-- ASN1START
-- TAG-CSI-REPORTCONFIG-START

| | |
|---|---|
| CSI-ReportConfig ::= | SEQUENCE { |

| reportConfigId | CSI-ReportConfigId, | |
|---|---|---|
| carrier | ServCellIndex | OPTIONAL, -- |

Need S

| resourcesForChannelMeasurement | CSI-ResourceConfigId, | |
|---|---|---|
| csi-IM-ResourcesForInterference | CSI-ResourceConfigId | OPTIONAL, -- |

Need R

| | | |
|---|---|---|
| nzp-CSI-RS-ResourcesForInterference | CSI-ResourceConfigId | OPTIONAL, -- |

Need R

<omitted text>

| ENUMERATED {n1, n2} | | OPTIONAL, -- Need R |
|---|---|---|
| groupBasedBeamReporting | | CHOICE { |
| enabled | | NULL, |
| disabled | | SEQUENCE { |
| | nrofReportedRS | ENUMERATED {n1, n2, n3, n4} |

| | |
|---|---|
| OPTIONAL | -- Need S |

```
    }
  },
```

| | |
|---|---|
| cqi-Table | ENUMERATED {table1, table2, table3, spare1} |

| | |
|---|---|
| OPTIONAL, | -- Need R |

Combining the group-based beam reporting mechanism with the example scenario shown in FIG. 4 allows the UE to report back multiple combinations of beam pairs. The following discussion assumes only 3 reports are allowed due to limited feedback overhead.

In one variant, the UE may report beam pairs (#Q1, #Q2), (#Q3, #Q1), (#P1, #P2). In this case, there is no useful combination for multi-TRP operation. There can be two outcomes, the network requests additional beam pairs or multi-DCI based multi-TRP is not supported for the UE.

In another variant, the UE may report, beam pairs (#P1, #Q2), (#Q3, #Q2), (#P1, #P2). However, the network does not become aware of the panel assumption used at the UE on single or multiple panel reception when reporting these pairs. Rel-15 allows the UE to report beams that can be received in single or multiple panels, and no differentiation is done for two modes.

If the network takes a conservative approach, multi-DCI based multi-TRP is supported for the UE with a limited set of beams (in this example, only (#P1, #Q2) by two TRPs).

If the network takes a less conservative approach and the network assumes (#Q3, #Q2) and (#P1, #P2) pairs are from a single panel reception, multi-DCI based multi-TRP is supported for the UE with a set of beam pairs (#P1, #Q2), (#P1, #Q3), (#P2, #Q2), (#P2, #Q3). However, two combinations ((#P1, #Q3)(#P2, #Q3)) are received at the same panel and multi-DCI based multi-TRP transmission will be in error.

The problem mentioned by above examples impact differently to different multi-TRP schemes.

In single DCI based multi-TRP transmission (with ideal BH between TRPs), the reported beam pairs may belong to the same or different TRPs. The UE reporting may be inefficient as the network relies on multiple reports to identify which beam pairs that UE can simultaneously receive via multiple TRPs. With a larger number of reports, beam pairs that are activated by the TRPs can be coordinated such that the UE receives the data transmission simultaneously.

In multi DCI based multi-TRP transmission (which may support non-ideal BH as well), beam-groups reported by the UE may belong to the same or different TRPs (in other words, reporting is not under the control of the network, so the reporting is inefficient).

Additionally, in both ideal and non-ideal BH situation, TCI states are dynamically indicated by DCI (from each TRP). The scheduled TCI states cannot be coordinated between TRPs when there is non-ideal BH. Therefore, certain beam combinations used by TRPs cannot be simultaneously received by the UE. To avoid this, indicated TCI state (from TRP1) should have multiple matching TCI states in TRP2. Such flexibility may require a significant amount of feedback of beam pairs using Rel-15 framework (as the scheme is not network controlled). This also takes time and beams may be outdated when used.

Based on Rel-15 mechanism, at least at the network side, RS used for beams may be coordinated between TRPs (e.g. the CSI RS resources to be used by each TRP). Thus, the network can differentiate that group-based beam reporting is valid per TRP or across TRPs. However, the UE may not efficiently operate when measuring CSI-RS and may waste reporting resources (as multiple reporting instances may be needed to carry enough information towards the network).

Based on Rel-15 mechanism, at least at the network side, it is not clear that the beams are received with two panels or with a single panel. That information is not transparent towards the network.
“if the UE is configured with the higher layer parameter groupBasedBeamReporting set to ‘enabled’, the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.”

In FR2, the multi-TRP transmission is received with more than one panel and above reporting mechanism may help the network to determine the beams that can be used simultaneously at TRPs. Therefore, when the UE is configured with CORESETs that has two different values for CORESETPoolIndex, the UE behaviour for reporting assumption shall be modified.

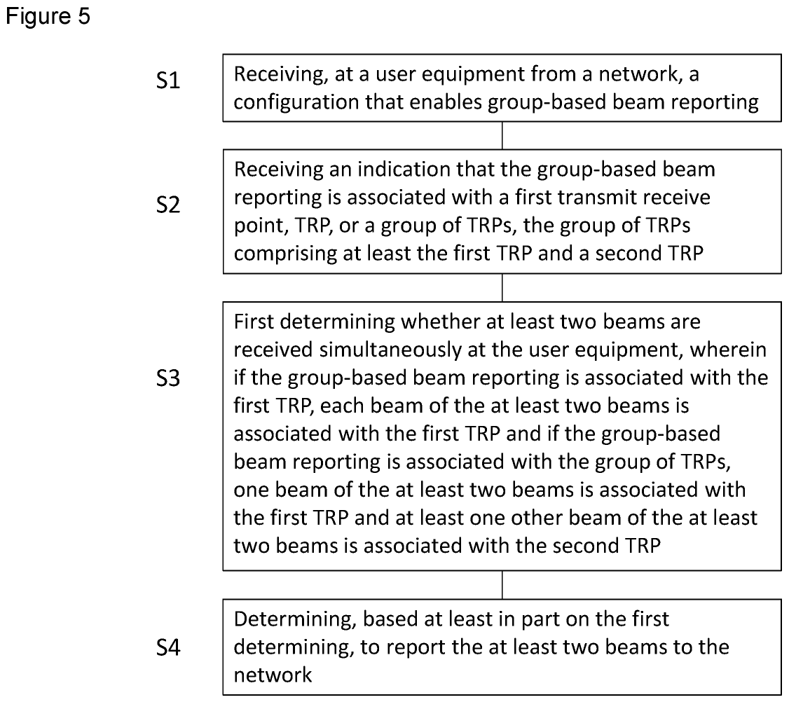

FIG. 5 shows a method according to an example embodiment. The method may be performed at a user equipment.

In a first step, S1, the method comprises receiving, at a user equipment from a network, a configuration that enables group-based beam reporting.

In a second step, S2, the method comprises receiving an indication that the group-based beam reporting is associated with a first transmit receive point, TRP, or a group of TRPs, the group of TRPs comprising at least the first TRP and a second TRP.

In a third step, S3, the method comprises first determining whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

If so, in a fourth step S4, the method comprises determining, based at least in part on the first determining, to report the at least two beams to the network.

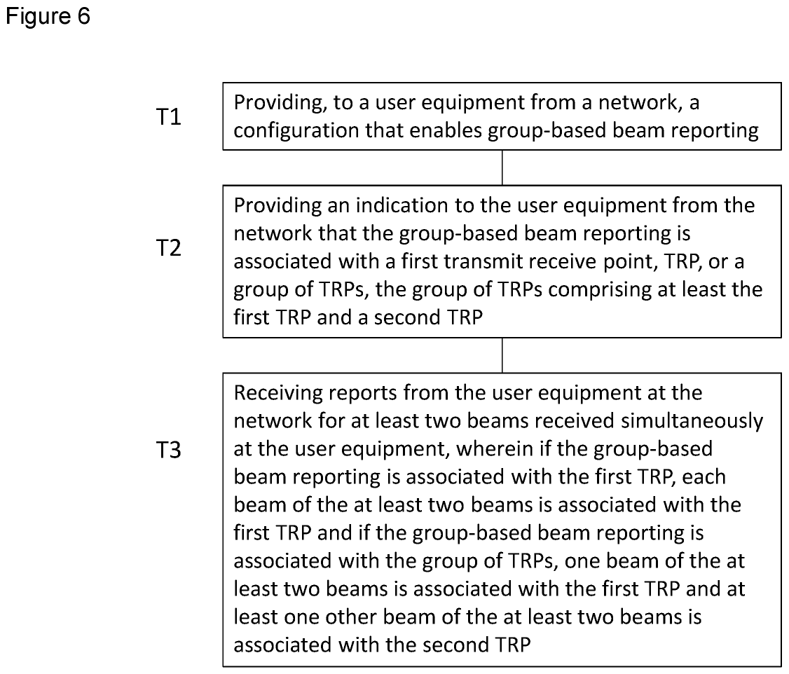

FIG. 6 shows a method according to an example embodiment. The method may be performed at a network.

In a first step, T1, the method comprises providing, to a user equipment from a network, a configuration that enables group-based beam reporting.

In a second step, T2, the method comprises providing an indication to the user equipment from the network that the group-based beam reporting is associated with a first transmit receive point, TRP, or a group of TRPs, the group of TRPs comprising at least the first TRP and a second TRP.

In a third step, T3, the method comprises receiving reports from the user equipment at the network for at least two beams received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

The beams may be identified based on channel state information reference signals (CSI-RS) resources or synchronization/PBCH block (SSB) indexes. Determining whether at least two beams are received simultaneously may comprise performing beam measurements for at least two beams associated with the first TRP or one beam of the at least two beams associated with the first TRP and at least one other beam of the at least two beams associated with the second TRP and determining whether the at least two beams are received simultaneously at the user equipment.

That is, when the UE is supported by multi-DCI based multi-TRP transmission, and if the UE configured with group-based beam reporting, it may be indicated to the UE that group-based beam reporting shall be applied per TRP or across TRPs.

For event based reporting, the reception of simultaneous beams from a first TRP (in the case of per TRP reporting) or from a first TRP and a second TRP (in the case of across TRP reporting) may be configured as an event. Other events may also be configured to trigger the reporting (e.g., comparing the RSRP of the at least two beams to a threshold).

When the group-based beam reporting is configured to be applied across TRPs, i.e., if the group-based beam reporting is associated with the group of TRPs, the UE reports at least two beams that can be received simultaneously, with beam reporting comprising of reporting at least two beams, wherein one beam is associated with the first TRP and at least one other beam is with the second TRP. The two beams may comprise resources that are received at the user equipment with multiple spatial domain receive filters.

The step of first determining may comprise determining whether the beam of the at least two beams associated with the first TRP is received at a first panel and the at least one other beam of the at least two beams associated with the second TRP is received at a second panel. That is, the UE may always maintain a given panel for a given TRP. For event based reporting, the reception of a beam of the at least two simultaneous beams at the given panel for a the given TRP may be configured as an event. Alternatively, or in addition, the method may comprise providing an indicator (e.g., a panel ID) of the first panel and an indicator of the second panel from the user equipment to the network. If the panel ID is reported, this condition may not be needed as reporting can already indicate panel(s) used.

In one example embodiment, based on the scenario shown in FIG. 4, the UE may report Beam #P1 received from TRP #1, and Beam #Q1 received from TRP2. In another example embodiment, based on the scenario shown in FIG. 4, the UE may report Beam #P1 received from TRP1, and Beam #Q1, Q2, . . . Q #K received from TRP2, and any beam pairs of (Beam #P1, Beam #Qk) where k=1, . . . K, may be used in multi-DCI based multi-TRP transmission.

When the group-based beam reporting is configured to be applied per TRP, i.e., if the group-based beam reporting is associated with the first TRP, the UE reports at least two beams that can be received simultaneously, with beam reporting consisted of reporting at least two beams, wherein the at least two beams are associated with a given TRP. The at least two beams may comprise resources which are received at the user equipment using a single spatial receive filter. In an example embodiment, when the group-based beam reporting is configured to be applied per TRP, the UE shall only report CSI-RS and/or SSB resource indicators if those beams can be received with a single spatial domain receive filter.

The user equipment may comprise at least two panels. The step of first determining may comprise determining whether the at least two beams associated with the first TRP are received at a first panel of the at least two panels. That is, the same panel is used for a given TRP. For event based reporting, the reception of the at least two simultaneous beams from the first TRP at the given panel may be configured as an event. Alternatively, or in addition, as in the across TRP embodiment, the method may comprise providing an indicator of the first panel to the network.

In the example embodiment shown in FIG. 4, the UE may report Beam #P1 and Beam #P2 received from TRP #1.

The network may use one or both configurations (per TRP and across TRP) to determine the efficient mode of operation, single TRP or multi-TRP transmission and/or to determine the beams per TRP when supporting multi-DCI based multi-TRP transmission.

In one example embodiment, TRP1 may receive per TRP beam report as (Beam #P1, Beam #P2) and across TRP beam report as (Beam #P1, Beam #Q1), and the network may decide to use (Beam #P1, Beam #Q1) and (Beam #P2, Beam #Q1) to support multi-DCI based multi-TRP transmission.

In another example embodiment, the TRPs may require multiple combinations of beam reports prior to deciding TCI activation via MAC-CE. TCI states activated for TRP1 (maximum 8 per TRP in Rel-16) may have many-to-many relation with the TCI states activated for TRP2.

In another example embodiment, the TRPs may limit the use of TCI states to a given set and only changed to a different set after coordinating with the other TRP. The other TRP may also adjust the used TCI states based on such coordination.

The indication that the group-based beam reporting is associated with a group of TRPs or with a first TRP may be provided via RRC, MAC CE, or via DCI if the indication is explicit. In another example embodiment, the indication may be implicit (e.g. across-TRP group-based beam reporting applies when the multi-DCI based multi-TRP is supported (e.g. MAC CEs activating two different sets of TCI states for the UE)).

The indication that the group-based beam reporting is associated with a group of TRPs or with a first TRP may be a higher layer parameter. That is, a higher layer parameter may be used to configure that group-based beam reporting is applied across TRPs or per TRP.

In another example embodiment, the indication may be an implicit principal (without the additional higher layer parameter) to determine whether group-based beam reporting is per TRP or across TRP.

In one variant, the higher layer parameter (e.g., CORESETPoolIndex) configured within CORESETs may be used as the implicit principal when deciding per TRP or across TRP group-based beam reporting. When the UE is configured to receive multi-TRP transmission (two different values of CORESETPoolIndex are configured for CORESETs), and if the group-based beam reporting is configured, the group-based beam reporting is applied across TRPs.

When the UE is configured to receive single TRP transmission (single value of CORESETPoolIndex is configured for CORESETs or CORESETPoolIndex is not configured), and if the group-based beam reporting is configured, the group-based beam reporting is applied per TRP.

The method may comprise associating a beam received at the user equipment with at least one of the first TRP and the second TRP based on the configuration that enables group-based beam reporting.

Associating the beam received at the user equipment with at least one of the first TRP and the second TRP may be based on a higher layer index or a quasi co-location reference. The beams associated with the TRPs may be further indicated based on the higher layer index configured per CORESET (CORESETPoolIndex) and relating this higher layer index to a given CSI-RS or SSB transmission. Alternatively, or in addition, the beams associated with the TRP may be derived by the UE. The derivation at the UE may be based on the QCL reference of the CSI-RS resource.

The method may comprise providing at least two identifiers (e.g., the identifier may be a beam index), each identifier associated with one of the at least two beams from the user equipment to the network.

Determining to report the at least two beams may comprise providing an indication of a beam measurement for each of the at least two beams. The beam measurement for a beam may comprise an indication of the RSRP for that beam. Both non- and differential based reporting for group-based beam reporting may be supported, as in NR Rel-15. A reporting format may be reused among non- and group-based schemes. When the number of reported CRIs is larger than one, differential reporting is used. The specification defines that 7 bit-length field is reserved to indicate quantized measured L1-RSRP between the largest and smallest L1-RSRP value (−140 dBm to −44 dBm). Additionally, in the specification, 4 bit-length fields are reserved to indicate differentially coded L1-RSRP value with respect to the maximum value with 2-bit step-size.

If it is determined that at least two beams are not received simultaneously at the user equipment, the method may comprise determining to report a strongest beam received at the user equipment and providing an indication of a beam measurement for the strongest beam and a null indication to the network.

The method may comprise, in response to receiving the beam measurements from the user equipment at the network, providing an indication from the network to the user equipment to enable further group-based beam reporting, wherein the further group-based beam reporting is associated with the group of TRPs or the first TRP and modifying transmission configuration indicator states associated with a given TRP.

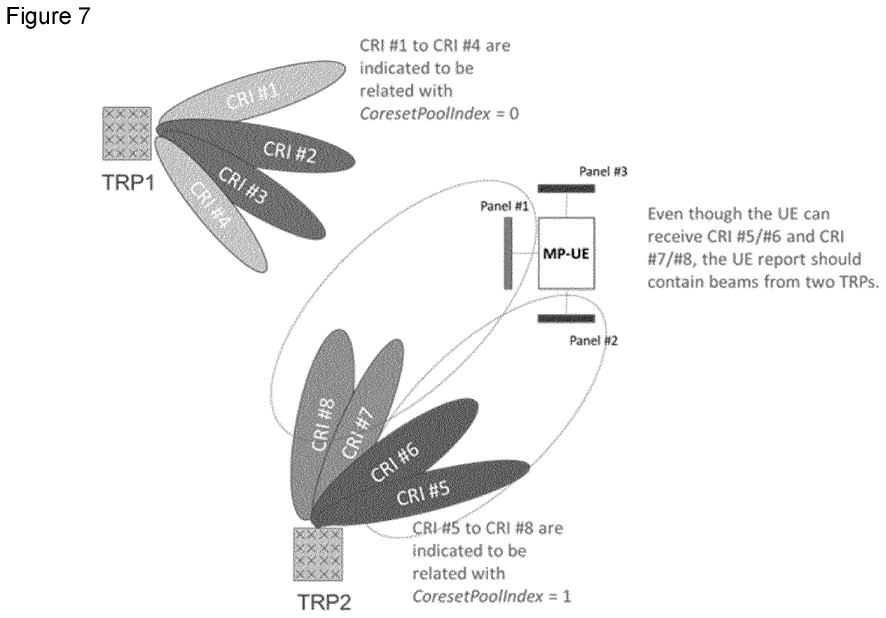

FIG. 7 illustrates an example embodiment where group-based beam reporting is applied across TRPs, where group-based beam report shall have at least one beam associated with the first TRP and at least one beam associated with the second TRP. In the example shown in FIG. 7, eight CRIs may be reported by the UE (which are related to two different TRPs—TRP1 and TRP2).

CR #1 to CR #4 are indicated to be related to TRP1 with CORESETPoolIndex=0. CRI #5 to CRI #8 are indicated to be related with CORESETPoolIndex=1. Even though the UE can receive CR #5/#6 and CRI #7/#8, the UE report should contain beams from two TRPs.

When the number of reported RS is two, the UE may report (CRI #2, CRI #6) with related RSRP (absolute or differential), where the combination can be received simultaneously.

When the number of reported RS is three, UE may report (CRI #2, CRI #6, CRI #5) with related RSRP (absolute or differential), where reporting implies that (CRI #2, CRI #6) and (CRI #2, CRI #5) can be received simultaneously.

When the number of reported RS is four, UE may report (CRI #2, CRI #3, CRI #6, CRI #5) with related RSRP (absolute or differential), where reporting implies that all combinations of two TRPs can be received simultaneously.

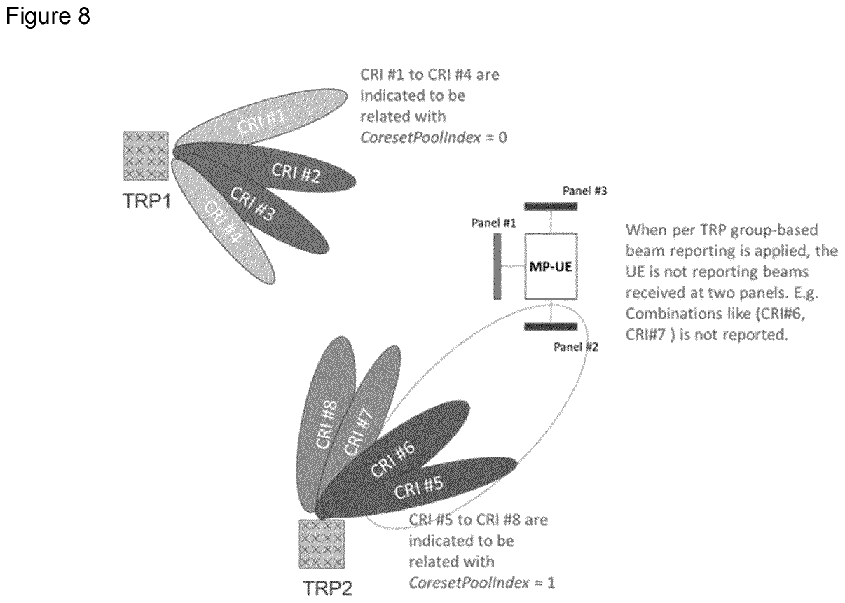

FIG. 8 illustrates an example embodiment where group-based beam reporting is applied per TRP.

In FIG. 8, eight CRIs may be reported by the UE (which are related to different TRPs). CR #1 to CR #4 are indicated to be related to TRP1 with CORESETPoolIndex=0. CRI #5 to CRI #8 are indicated to be related with CORESETPoolIndex=1.

The UE may report (CRI #5, CRI #6) with related RSRP (absolute or differential), where the combination can be received simultaneously by a given panel.

The UE may report (CRI #7, CRI #8) with related RSRP (absolute or differential), where the combination can be received simultaneously by a given panel.

Similarly, beam group reporting may be performed separately for TRP1.

If there is no additional enhancement on reporting panel-ID from the UE with the above beam reporting, the network may configure the UE with across TRP group-based beam reporting to get the feedback from the UE about other TRP beam combinations (CRI #2, CRI #6) such that network can decide which beams that UE may be capable of receiving simultaneously.

If there is an additional enhancement on reporting panel-ID from the UE with the above beam reporting, the network may derive beams that can be used simultaneously such that panels are shared between TRPs.

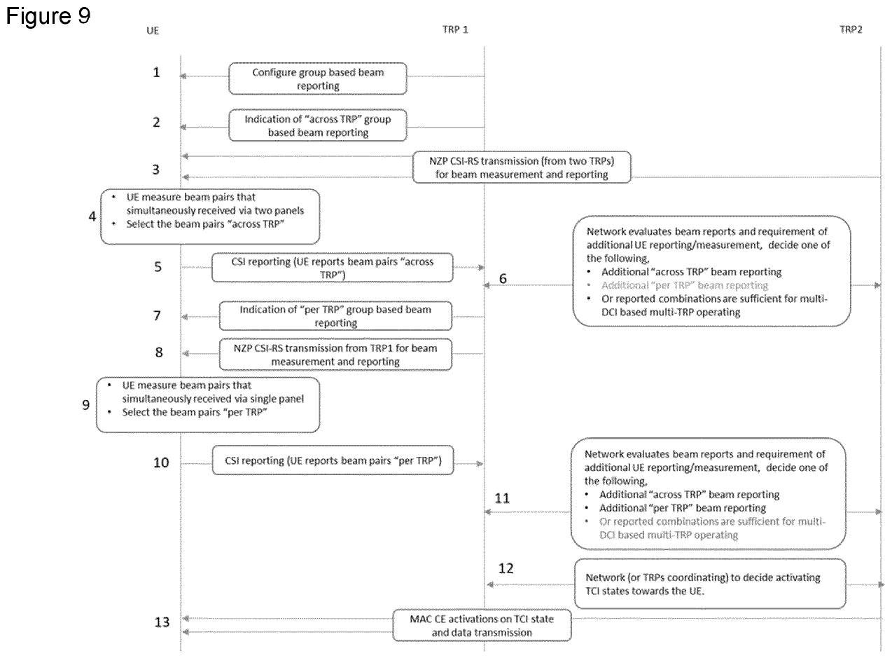

FIG. 9 shows a signalling diagram for enhanced group-based beam reporting according to an example embodiment.

In the first step shown in FIG. 9, the network configures the UE with CSI reporting configurations that enable group-based beam reporting (group-based beam reporting is enabled within CSI-ReportingConfig). Within the CSI reporting configuration, associated RS for the beam (the above example assumes non zero power (NZP)-CSI-RS) may also be indicated to the user equipment by the network.

In the second step, the network configures or indicates across-TRP beam reporting for the upcoming CSI reporting (group-based beam reporting) instances.

In the third step, associated NZP-CSI RS resources (with corresponding beams) are transmitted via multiple TRPs. This CSI-RS corresponding to multiple beams that are transmitted via multiple TRPs such that UE has enough combinations to report towards the network. This step may be related to the Rel-15 P-2 stage of the beam management, where DL TX beam tracking based on CSI-RS for L1-RSRP. Here, the UE is configured with a CSI-RS resource set configured with “repetition=OFF”, the CSI-RS resource set is composed of multiple CSI-RS resources having different TCI states (different beams).

The beams (CSI-RS) associated with per TRP may be indicated or derived by the UE (to map onto different panels at the UE). The indication may be based on the higher layer index CORESETPoolIndex and associating that to a give CSI-RS resource (beam). Alternatively, the derivation at the UE may be based on the QCL reference of the CSI-RS resource. After the initial beam management stage (P-1 stage in Rel-15), the used CSI-RS resource (narrow beam) already mentioning associated TCI state (mostly SSB beam) to use as the QCL reference (P-1 stage uses a wider beam), and this SSBs associated with a TRP.

In a fourth step, the UE performs the beam measurement, where the UE selects CSI-RS resources (across TRP) that can be received simultaneously by the UE (e.g., with multiple simultaneous spatial domain receive filters).

In a fifth step, the UE reports group based beam reporting (via CSI reporting) towards the network (TRP1 in FIG. 9).

If the network configures up to 4 CRIs and associated with L1-RSRP values to be reported, the UE may report CRIs associated with two TRPs, where CRIs that indicated first may be related to first TRP (CORESETPoolIndex=0).

In the sixth step, when the reports are received at the network, depending on how many combinations that received, the network may trigger further reports ‘across TRP” (repeat steps 3-5), or trigger “per TRP’ group-based beam reporting, or change/activate TCI states via MAC-CE signalling per TRP.

In one variant, if further reports on across TRP are needed, the TRPs may use a different set of Tx beams.

In another variant, if the wider beams are used by a TRP (TRP1) compared to other TRP (TRP2), per TRP group based beam reporting can be triggered for TRP1. That may allow faster beam refinement for TRP1 while satisfying multi-TRP reception. This example is further illustrated in steps 7 to 11 of FIG. 9.

In step seven, the network indicates per TRP group based beam reporting. This step may not be supported if the indication is implicit (when the multi-DCI based multi-TRP is supported (e.g. if MAC CE already indicated two different sets of TCI states for the UE)).

In the eighth step, associated NZP-CSI RS resources (with corresponding beams) for the CSI reporting configuration is transmitted via TRP1. This CSI-RS corresponding to multiple beams that are transmitted via the same TRP such that the UE can perform beam refinement.

In the ninth step, the UE performs the beam measurement, where the UE selects CSI-RS resources (per TRP) that can be received simultaneously by the UE (e.g., with a single spatial domain receive filter). The UE may always maintain a given panel for given TRP (the same panel used for TRP1 in the above previous report).

In another variant, if the panel ID can be also reported, the above restriction may not be needed as reporting may already indicate panel(s) used.

In a tenth step, the UE reports group based beam reporting via CSI reporting towards the network.

In an eleventh step, when the reports are received at the network, depending on how many combinations that received, the network can trigger further reports ‘across TRP” (repeat steps 3-5), use a different mode “per TRP’ group-based beam reporting, or change/activate TCI states via MAC-CE signalling per TRP.

If the number of combinations reported by the UE is sufficient to support multi DCI based multi-TRP transmission, the network proceeds to steps 12 and 13.

In step 12, the network coordinates on useful TCI states (based on the CRIs that reported) towards the UE, where multiple combinations of TCI states used in different TRPs can be simultaneously received at the UE.

In step 13, TRPs activate TCI states via independent MAC-CE messages for multi-DCI based multi-TRP scheme or one MAC-CE message for single DCI based multi-TRP, and used via DCI for later data transmission.

In other variants, some of the steps 1 to 12 may happen simultaneously.

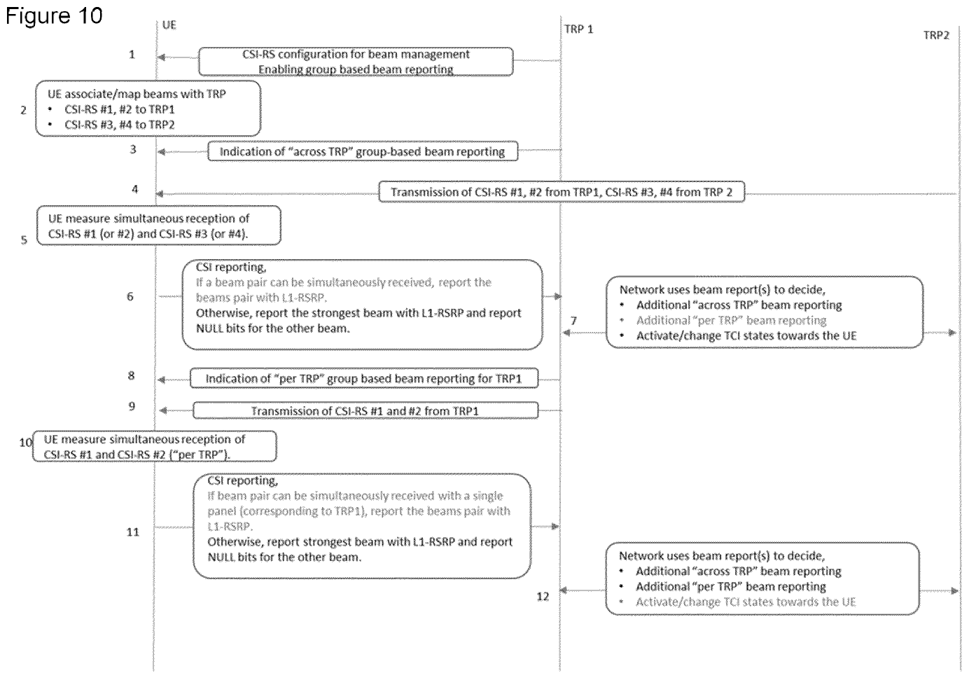

FIG. 10 shows an example signalling diagram for across TRP and per TRP group-based reporting.

In step 1, the UE receives a CSI-RS configuration for beam measurement and reporting, where CSI reporting configuration enables the group-based beam reporting.

In step 2, based on the received CSI-RS configuration, the beams (CSI-RS) associated with a TRP may be indicated or derived by the UE. In the example of FIG. 9, CSI-RS #1 and #2 are identified to be used by TRP1, and TRP2 uses the other CSI-RS.

In step 3, the UE receives a configuration or indication of the “across-TRP” group-based beam reporting for the upcoming CSI reporting (group-based beam reporting) instances.

In step 4, TRP1 transmits CSI-RS #1, CSI-RS #2 (corresponding to beams), while TRP2 transmits CSI-RS #3, CSI-RS #4.

In step 5, the UE performs the beam measurement, where the UE selects CSI-RS resources (across TRP) that can be received simultaneously by the UE (e.g., with multiple simultaneous spatial domain receive filters).

In step 6, the UE reports a beam pair based on the measured beams. If at least one beam pair from (CSI-RS #1, CSI-RS #3), (CSI-RS #1, CSI-RS #4), (CSI-RS #2, CSI-RS #3), or (CSI-RS #2, CSI-RS #4) can be received simultaneously, the UE reports a beam pair. Otherwise, the UE may report the strongest beam and bits dedicated to indicating the second beam may be set to zero.

At step 7, the network node may use the reported beam pair to decide further actions. Actions may include additional CSI reporting with across TRP group-based beam reporting, triggering of per TRP group-based beam reporting, or using the reported beams to activate TCI states required for data transmission.

At step 8, the UE receives a configuration or indication of the “per-TRP” group-based beam reporting for the upcoming CSI reporting (group-based beam reporting) instances.

At step 9, TRP1 transmits CSI-RS #1, CSI-RS #2 (corresponding to beams). This is to enable more combinations of beams that can be related to the previous report (at step 6).

At step 10, the UE performs the beam measurement, where the UE selects CSI-RS resources (per TRP) that can be received simultaneously by the UE (e.g., with single spatial domain receive filter).

At step 11, the UE reports a beam pair based on the measured beams. If at least one beam pair from (CSI-RS #1, CSI-RS #2) can be received simultaneously, the UE reports a beam pair. Otherwise, the UE may report the strongest beam and bits dedicated to indicating the second beam may be set to zero.

Step 7 is then repeated at the network.

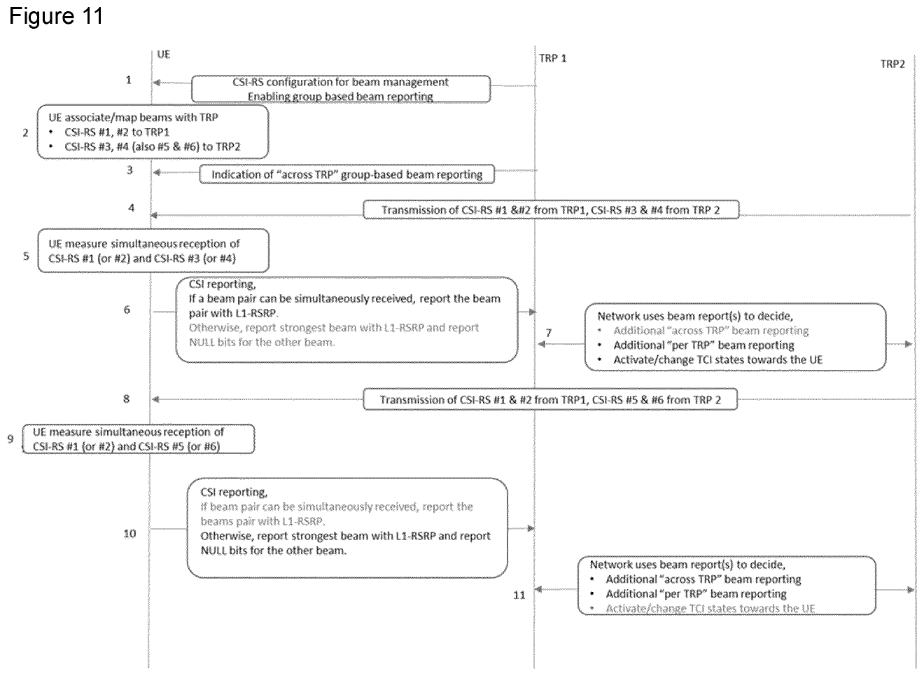

In another variant, shown in FIG. 11, the network may trigger only across TRP beam reporting. Steps 1 to 7 of FIG. 11 are the same as in FIG. 10.

At step 7, the network determines to perform additional across TRP beam reporting.

In step 8, TRP1 transmits CSI-RS #1, CSI-RS #2 (corresponding to beams), while TRP2 transmits CSI-RS #5, CSI-RS #6. Here, TRP2 sends a different set of beams to find more pairs that capable of receiving simultaneously.

In step 9, similarly to step 5, the UE performs the beam measurement, where the UE selects CSI-RS resources (across TRP) that can be received simultaneously by the UE (with multiple simultaneous spatial domain receive filters).

In step 10, similarly to step 6, the UE reports a beam pair based on the measured beams. If at least one beam pair from (CSI-RS #1, CSI-RS #5), (CSI-RS #1, CSI-RS #6), (CSI-RS #2, CSI-RS #5), or (CSI-RS #2, CSI-RS #6) can be received simultaneously, the UE reports a beam pair. Otherwise, the UE may report the strongest beam and bits dedicated to indicating the second beam may be set to zero.

In step 11, step 7 is repeated.

The method may be implemented in a user equipment as described with reference to FIG. 2 or a control apparatus as described with reference to FIG. 3.

An apparatus may comprise means for receiving, at a user equipment from a network, a configuration that enables group-based beam reporting, receiving an indication that the group-based beam reporting is associated with a first transmit receive point, TRP, or a group of TRPs, the group of TRPs comprising at least the first TRP and a second TRP, first determining whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP; and, if so, determining, based at least in part on the first determining, to report the at least two beams to the network.

Alternatively, or in addition, an apparatus may comprise means for providing, to a user equipment from a network, a configuration that enables group-based beam reporting, providing an indication to the user equipment from the network that the group-based beam reporting is associated with a first transmit receive point, TRP, or a group of TRPs, the group of TRPs comprising at least the first TRP and a second TRP and receiving reports from the user equipment at the network for at least two beams received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where multiple TRPs are in use. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various example embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Example embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more embodiments with any of the other embodiments previously discussed.

1. An apparatus comprising:
at least one processor; and
at least one memory including computer program code;
the at least one memory and the computer program code configured to, with the at least one processor, cause the apparatus at least to:
receive, at a user equipment from a network, a configuration that enables group-based beam reporting;
receive an indication that the group-based beam reporting is associated with a first transmit receive point, TRP, or a group of TRPs, the group of TRPs comprising at least the first TRP and a second TRP;
first determine whether at least two beams are received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP; and, if so
determine, based at least in part on the first determining, to report the at least two beams to the network.

2. The apparatus according to claim 1, wherein if the group-based beam reporting is associated with the group of TRPs, the at least two beams comprise resources which are received at the user equipment using multiple spatial receive filters.

3. The apparatus according to claim 1, wherein the at least one processor and the computer program code are further configured to cause the apparatus to:
if the group-based beam reporting is associated with the group of TRPs, determine whether the beam of the at least two beams associated with the first TRP is received at a first panel and the at least one other beam of the at least two beams associated with the second TRP is received at a second panel.

4. The apparatus according to claim 1, wherein if the group-based beam reporting is associated with the first TRP, the at least two beams comprise resources which are received at the user equipment using a single spatial receive filter.

5. The apparatus according to claim 1, wherein the at least one processor and the computer program code are further configured to cause the apparatus to:
if the group-based beam reporting is associated with the first TRP, determine whether the at least two beams associated with the first TRP are received at a given panel of at least two panels of the user equipment.

6. The apparatus according to claim 1, wherein the at least one processor and the computer program code are further configured to cause the apparatus to:
provide at least two identifiers from the user equipment to the network, each identifier associated with one of the at least two beams.

7. The apparatus according to claim 1, wherein the at least one processor and the computer program code configured to determine report the at least two beams comprises the at least one processor and the computer program code configured to cause the apparatus to provide an indication of a beam measurement for each of the at least two beams.

8. The apparatus according to claim 1, wherein the at least one processor and the computer program code are configured to cause the apparatus to:
determine that at least two beams are not received simultaneously at the user equipment;
determine to report a strongest beam received at the user equipment; and
provide an indication of a beam measurement for the strongest beam and a null indication to the network.

9. The apparatus according to claim 1, wherein the at least one processor and the computer program code are configured to cause the apparatus to:
associate a beam received at the user equipment with at least one of the first TRP and the second TRP based on the configuration that enables group-based beam reporting.

10. The apparatus according to claim 9, wherein the at least one processor and the computer program code are configured to cause the apparatus to:
associate the beam received at the user equipment with at least one of the first TRP and the second TRP based on a higher layer index or a quasi co-location reference.

11. The apparatus according to claim 1, wherein the indication that the group-based beam reporting is associated with the group of TRPs or that the group-based beam reporting is associated with the first TRP comprises a higher layer index.

12. The apparatus according to claim 10, wherein the higher layer index is associated with a CORESET.

13. The apparatus according to claim 1, wherein the at least one processor and the computer program code are configured to cause the apparatus to:
receive the indication at the user equipment from the network in dynamic signalling.

14. An apparatus comprising:
at least one processor; and
at least one memory including computer program code;
the at least one memory and the computer program code configured to, with the at least one processor, cause the apparatus at least to:
provide, to a user equipment from a network, a configuration that enables group-based beam reporting;
provide an indication to the user equipment from the network that the group-based beam reporting is associated with a first transmit receive point, TRP, or a group of TRPs, the group of TRPs comprising at least the first TRP and a second TRP; and
receive reports from the user equipment at the network for at least two beams received simultaneously at the user equipment, wherein if the group-based beam reporting is associated with the first TRP, each beam of the at least two beams is associated with the first TRP and if the group-based beam reporting is associated with the group of TRPs, one beam of the at least two beams is associated with the first TRP and at least one other beam of the at least two beams is associated with the second TRP.

15. The apparatus according to claim 14, wherein the at least one processor and the computer program code are configured to cause the apparatus to:
receive at least two identifiers at the network from the user equipment, each identifier associated with one of the at least two beams.

16. The apparatus according to claim 14, wherein the at least one processor and the computer program code configured to cause the apparatus to receive reports for the at least two beams comprises the at least one processor and the computer program code configured to cause the apparatus to receive a beam measurement for each of the at least two beams.

17. The apparatus according to claim 16, wherein the at least one processor and the computer program code are configured to cause the apparatus to:
in response to receiving the beam measurements from the user equipment at the network, perform at least one of the following:
provide an indication from the user equipment to the user equipment to enable further group-based beam reporting, wherein the further group-based beam reporting is associated with the group of TRPs or the first TRP; and
modify transmission configuration indicator states associated with a given TRP.

18. The apparatus according to claim 14, wherein the at least one processor and the computer program code are configured to cause the apparatus to:
receive from the user equipment at the network an indication of beam measurement for a strongest beam received at the user equipment and a null indication.

19. The apparatus according to claim 14, wherein the indication that the group-based beam reporting is associated with the group of TRPs or that the group-based beam reporting is associated with the first TRP comprises a higher layer index.

20. The apparatus according to claim 19, wherein the higher layer index is associated with a CORESET.

21-27. (canceled)
